(19) United States
(12) Patent Application Publication
(10) Pub. No.: US 2018/0140135 A1
(43) Pub. Date: May 24, 2018

(54) COOKING STAND APPARATUS

(71) Applicant: Gottfried BALFANTZ, III, Metairie, LA (US)

(72) Inventor: Gottfried BALFANTZ, III, Metairie, LA (US)

(21) Appl. No.: 15/811,044

(22) Filed: Nov. 13, 2017

Related U.S. Application Data
(60) Provisional application No. 62/425,780, filed on Nov. 23, 2016.

(51) Int. Cl. A47J 37/07

(52) U.S. Cl. CPC A47J 37/0786; A47J 2037/0795

(57) ABSTRACT

A cooking stand apparatus has a plurality of legs, a post extending upwardly from the plurality of legs, and arm connected adjacent an upper end of the post opposite the plurality of legs, and a lifting assembly affixed adjacent an end of the arm away from the post. The lifting assembly is adapted to raise or lower an item relative to the plurality of legs. The arm angles upwardly from a lower end toward an upper end thereof. A handgrip is affixed to a lower end of the arm. The lifting assembly includes a reel, a line extending around the reel, and a hook or grasping device affixed to an end of the line. A handcrank or winch is cooperative the reel so as to raise or lower the end of the line.

### CROSS-REFERENCE TO RELATED APPLICATIONS

The present application claims priority from U.S. Provisional Patent Application Ser. No. 64/425,780, filed on Nov. 21, 2016, and entitled “Cooking Stand”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to cooking stands. More particularly, the present invention relates to devices and apparatus for the transfer of a cooking container from one location to another. More particularly, the present invention relates to cooking stands whereby the person that is doing the cooking can manipulate the cooking container from a location away from the heat source.

### 2. Description of Related Art Including Information Disclosed Under 37 CFR 1.97 and 37 CFR 1.98

Numerous types of outdoor grills have been developed over the years for supporting food above a heat source. Many of these devices are simple assemblies for securing a mesh or wire form grill a fixed height above a fire. For example, rocks or bricks can be used to support the grill. Wheel rims, on occasion, have been used to contain a fire and support the grill. Various other firebox assemblies with stationary or folding legs and grill covers of also been constructed.

Tripod grill supports are also known. These supports typically support a circular mesh grill beneath the apex of an assembled framework. The grill can be vertically adjustable on a chain or other hanger.

Some cooking assemblies provide an upright stanchion or stake, which is driven into the ground, adjacent fire, which can support one or more mesh platforms, griddles or grills. The grills can be adjusted vertically along the stanchion or the grills could be rotated away from the fire. A coupler at the grill may interconnect with a mating coupler secured along the stanchion or the coupler may permit a tilting action whereby the grill is held by friction to the stanchion.

It is known that the cooking of crawfish involves the lowering of a container of crawfish into a pot of boiling water. Typically, in the past, the pot of boiling water is placed upon a heat source, such as a fire or a grill. The person cooking the crawfish must then approach the heat source with the container of crawfish and then lower the container of crawfish into the boiling water. Under these circumstances, the person that is cooking must move into proximity to the pot of boiling water and to the heat source. As the crawfish-containing pot is lowered into the boiling water, there is a significant risk that water may splash and burn the person doing the cooking. In other circumstances, the person can be burned by the heat from the heat source. Still, in other more disastrous circumstances, the pot of boiling water spills on the person doing the cooking. This can result in severe burns and a possible hospital visit. As such, a need has developed so as to allow the person cooking the crawfish to stand away from the heat source and the boiling water while the crawfish are being placed into the container.

Turkey frying is a also a common activity. The turkey must be lowered into a vat of boiling oil. The person cooking the turkey must stand in proximity to the boiling oil in order to place the turkey into the boiling oil. Under certain circumstances where the turkey is frozen, the contact of the turkey with the boiling oil can cause an explosive event. In other circumstances, the weight of the turkey can cause the oil to splash on to the person doing the cooking. Still, in other circumstances, the pot of boiling oil can tip over when the turkey is dropped into the boiling oil. This can cause severe injury to the person doing the cooking, has been known to cause fires, and can injure bystanders and pets. As such, a need has developed so as to provide a device whereby a turkey can be conveniently lowered into the oil while minimizing the risk associated with such cooking activities.

In the past, variety of patents have issued with respect to various cooking devices. For example, U.S. Pat. No. 578,375, issued on Mar. 9, 1897 to L. E. Tyger, discloses a cooking stand. This stand includes a post, a clamp carried at the uppermost end of the post and having an externally threaded stud and a threaded thereon. A pan is provided having a keyhole-shape slot for receiving the stud and allowing the insertion of the nut thereinto with the stud engaging therein for clamping action by the clamp. An anchoring wing is carried by the post close to the anchoring end thereof.

U.S. Pat. No. 2,887,944, nation of May 26, 1959 to B. Walker, teaches a barbeque rotisserie. This work barbeque rotisserie includes a motor and a spit. The motor is connected to the spit to rotate the spit. The spit is supported for rotation at one end only of the spit. Either end of the spit fits into the support so as to be driven thereby and be secured therein for rotation by the motor. An offset prong is slidably mounted on the spit.

U.S. Pat. No. 4,065,085, issued on Dec. 27, 1977 to W. L. Gellaply, shows a fire pit hanger that is removably or permanently mounted adjacent to a barbecue pit so that vessels for food and cooking items can be suspended over an open fire for cooking purposes. A support arm is vertically adjustable on a support post. Swivel hooks are adjustably positioned on the support arm to carry food or food vessels. One of the swivel hooks positively locks the arm in position on the post.

U.S. Pat. No. 4,437,450, issued on Mar. 20, 1984 to W. L. Connelly, teaches a portable cooking stand for indoor and outdoor use. The stand includes a post and at least one grill assembly swingably and slidably mounted thereon. Each grill assembly has a sleeve slip mounted on the post, a grill support in the form of a rod and generally in the shape of a vee and having the nip portion thereof circumscribing the sleeve and rigidly secured thereto, and an open grill resting on and secured to the grill support. A grill assembly support means is slidably mounted on the post below the sleeve of the grill assembly and includes a lock for securing to the post at any position longitudinally therealong.

U.S. Pat. No. 4,607,608, issued on Aug. 26, 1986 to Allred et al., provides a campfire griddle or grill which is designed for convenience for cooking over a campfire. A metal support in the form of a stake is driven into the ground by stepping on a footpad. The griddle handle is then placed over the stake and lowered to the desired height. The handle can be adjusted to different heights by depressing the safety latch while lowering and the griddle can be swung away from the fire, as desired.

U.S. Pat. No. 5,944,009, issued on Aug. 31, 1999 to K. T. Scheller, provides a portable outdoor grill which permits adjustment of a food support platform in three dimensions. A ground support accepts a trust stanchion and permits rotation of the stanchion. The ground support can be a tubular ground stake or can be a support stand. A swing arm is reciprocally mounted to the stanchion and supports one or more couplers having support hooks, a chain, and an S-hook. A harness is suspended from the S-hook and secured to a cooking platform.

U.S. Pat. No. 6,578,568, issued on Jun. 17, 2003 to Dufort et al., discloses a fire pit grill with a vertically foldable bracket on a rotatable sleeve. The fire pit grill has a vertical support that can be driven into the ground or otherwise supported in a vertical position. An adjustable stop can be set at any desired height on the vertical support. A sleeve and bracket rest on the stop so as to support a grill surface. The sleeve supports a handle whereby the bracket in the grill surface can be rotated over and away from a fire below the grill.

U.S. Pat. No. 6,719,250, issued on Apr. 13, 2004 to S. D. FitzSimons, teaches a backpacker's portable cooking stand that can be used for outdoor cooking and could be foldable to a compact configuration. The cooking stand include includes a cooking platform for mounting over a source of heat, and foldable legs that are pivoted to over center attitudes for stable use of the cooking stand over a fire. The legs can be folded to a compact configuration for traveling.

U.S. Pat. No. 6,827,077, issued on Dec. 7, 2004 to P. E. Haas, shows an assembly for cooking on a campfire. This assembly includes a vertical support that has an upper end and a pointed lower end. A grill support is attached to the vertical support and is selectively positionable between the upper and lower ends. The support is elongated and has a first end and a second end. A fastener selectively fastens the grill support in a fixed vertical position to the vertical support. A grill is attached and bounded by an upwardly extending peripheral wall. A plate has a peripheral edge and a hinge hingedly coupled to the peripheral edge of the inner surface of the peripheral wall. The plate is selectively positionable between a horizontal position extending over a grill and a vertical orientation extending upwardly away from the grill.

U.S. Pat. No. 7,007,687, issued on Mar. 7, 2006 K. A. Lewis, discloses a campfire cooking device that has a stake, a slide hammer on the stake, a horizontal support with a grilling surface, a frictional engager to hold the horizontal support to the stake, and a grill lifting tool. By using the grill lifting tool and a handle on the horizontal support, a cook can easily adjust the height of the grilling surface, even while the campfire is burning. The horizontal support can also be pivoted about the stake so the grilling surface can be swiveled on or off the fire.

It is an object of the present invention to provide a cooking stand that allows a container to be lifted and moved away from a heat source.

It is another object of the present invention to provide a cooking stand that keeps the hands of the user and the body of the user a safe distance from the heat source or the heated container.

It is another object of the present invention to provide a cooking stand that allows a container to be moved conveniently toward a heat source.

It is another object of the present invention to provide a cooking stand that elevates the container above the heat source.

It is another object of the present invention to provide a cooking stand that ensures stability of the heat source and the container.

It is another object of the present invention provide a cooking stand that is foldable, stowable, and easily transportable.

It is still another object of the present invention to provide a cooking stand that is easy-to-use, easy to manufacture, and relatively inexpensive.

It is a further object of the present invention to provide a cooking stand that facilitates the ability to fry turkeys and boil crawfish.

These and other objects and advantages of the present invention will become apparent from a reading of the attached specification and appended claims.

### BRIEF SUMMARY OF THE INVENTION

The present invention is a cooking stand that comprises a plurality of legs, a post extending upwardly from the plurality of legs, an arm connected to an end of the post opposite the plurality of legs, and a lifting assembly affixed to the arm so as to cause a raising and lowering of an item relative to the plurality of legs.

In the present invention, the plurality of legs comprises four legs that extend at 90° with respect to each other. Each of the legs has a lower end and an upper end. The lower end is suitable for resting on an underlying surface. The upper ends of the legs are pivotally attached to a collar that extends around the post. The collar is movable between an upper position and a lower position. In the upper position, the legs are retracted. In the lower position, the legs are extended. A line extends between the legs. This line limits the angular position of the legs in the extended position. This line has an end secured between the upper and lower ends of the leg.

The post has a first portion that is connected to the plurality of legs. The post also includes a second portion that is affixed to the first portion. The second portion can be rotatably mounted and axially aligned with respect to the first portion. The first and second portions extend vertically. In particular, the second portion has a flange thereon that extends radially outwardly of an exterior surface of the second portion of the post. This flange will serve to abut the top of the first portion of the post when the second portion is positioned within the first portion.

The arm extends at an angle upwardly from one end to the other. A handgrip is positioned at the lower end of the arm. The handgrip includes an angular section that angles downwardly at an obtuse angle with respect to a remainder of the arm. In particular, the arm has a first portion that extends radially outwardly of the post and a second portion that extends radially outwardly of the post. The first portion is axially aligned with the second portion. In particular, the first portion and the second portion can be integrally formed together. A tubular member extends downwardly from an underside of the arm. A first strut extends from the tubular member to the first portion of the arm. A second strut extends from the tubular member to the second portion of the arm. The tubular member can fit over the top of the second portion of the post and can be rotatably mounted thereon. The first portion of the arm has a longer length of the second portion of the arm.

The lifting assembly can be a winch, a hand crank or similar device. The winch or the hand crank of the lifting assembly can support a reel therein. A line extends around the reel and along the arm. An end of the line opposite the reel extends downwardly from the arm. A hook or other type of grasping device can be positioned at the end of the line. A plurality of rollers are located within the arm so as to support the line within the arm. A braking mechanism can be coupled with the winch or hand crank so as to fix a position of the opposite end of the line.

In the present invention, there can, optionally, be a foot that is affixed to the lower end of each of the legs. The foot is a diameter greater than the cross-section of the leg. The foot will extend in a horizontal orientation when the leg is extended. The foot has a hole extending therethrough. A stake is provided that can extend through the hole so as to fix the foot to an underlying surface in order to maintain the cooking stand in a stable configuration on uneven surfaces.

The reel of the lifting assembly causes the line to extend and retract. In particular, the reel allows the opposite end of the line to move directly upwardly or downwardly. As such, the hook or grasping device can grab a cooking container so as to lift the cooking container from the heat source.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view of the cooking stand in accordance with the present invention.

FIG. 2 is a plan view of the cooking stand of the present invention.

FIG. 3 is a plan view showing the foot as optionally used with the cooking stand of the present invention.

FIG. 4 is a side elevational exploded view of the cooking stand of the present invention.

### DETAILED DESCRIPTION OF THE INVENTION

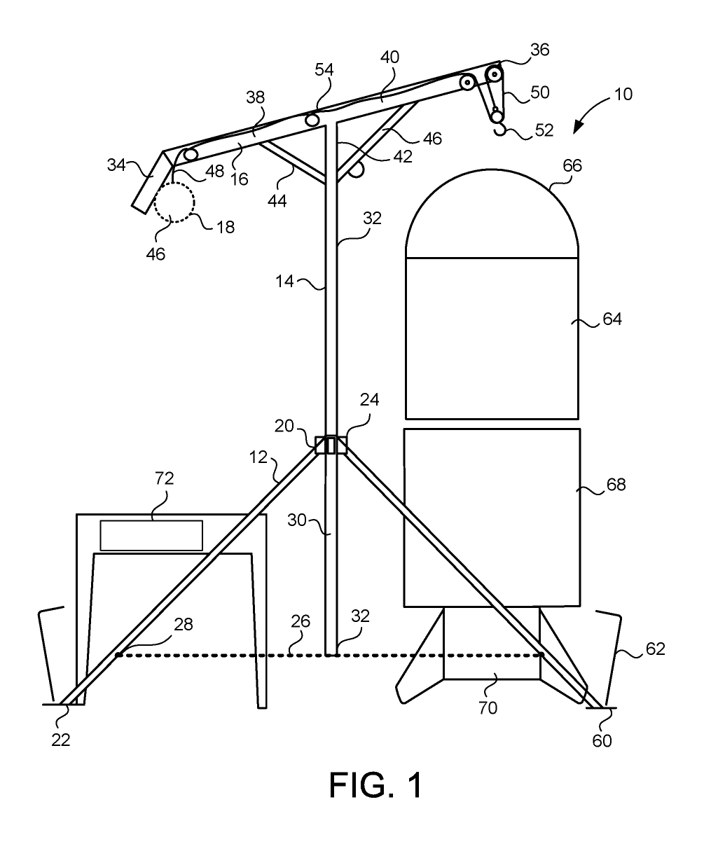

Referring to FIG. 1, there is shown the there is shown the cooking stand 10 in accordance with the preferred embodiment of the present invention. The cooking stand 10 includes a plurality of legs 12, a post 14 extending upwardly from the plurality of legs 12, an arm 16 connected to an end of the post 14 opposite the plurality of legs 12, and a lifting assembly 18 affixed to the arm 16 so as to cause a raising and lowering of an item in relation to the plurality of legs 12.

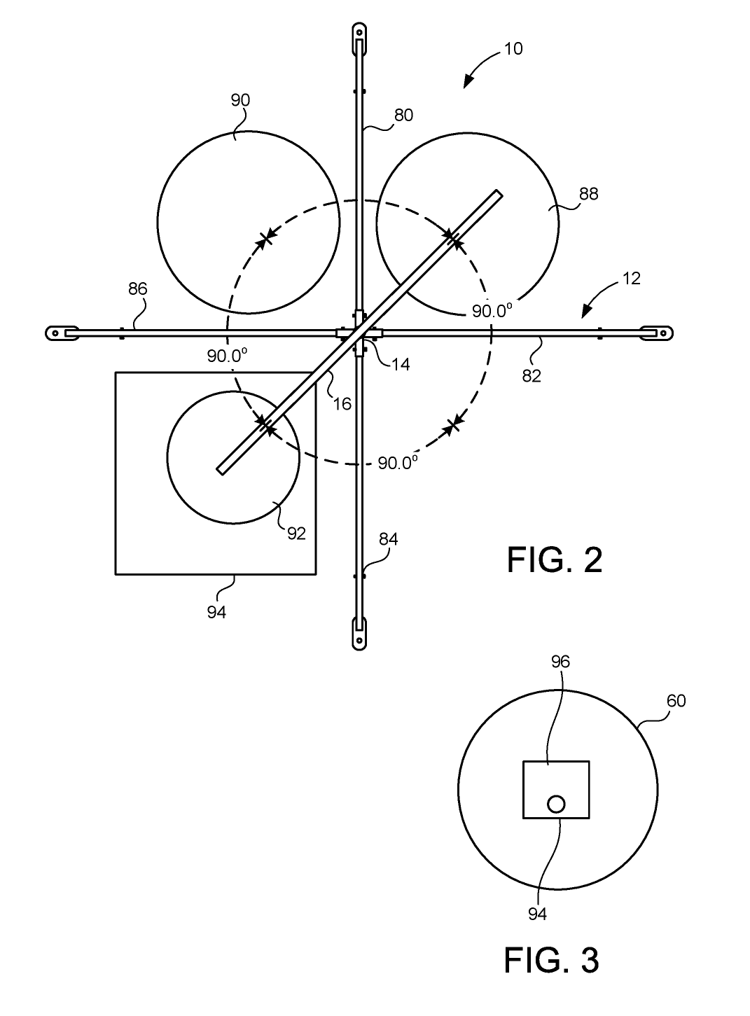

The plurality of legs 12 include four legs extending at 90° with respect to each other (as shown in FIG. 2). Each of the legs has an upper end 20 and a lower end 22. The lower end 22 is suitable for resting on an underlying surface. The upper end 20 is pivotally affixed to a collar 24. The collar 24 extends around the post 14. The collar 24 is movable between an upper position and a lower position. In the upper position, the plurality of legs 12 are retracted so as to reside in close proximity to the post 14. In the extended position (as shown in FIG. 1), the plurality of legs 12 are extended outwardly. A line 26 will extend from the lower end of the post 14 so as to connect with each of the plurality of legs 12. The line 26 has an end 28 that is affixed to each of the legs 12 in a location between the upper end 20 and the lower end 22. The line 26 is extended so as to limit the angular positions of the plurality of legs with respect to the post 14 when the plurality of legs 12 are in the extended position.

The post 14 has a first portion 30 and a second portion 32. The first portion 30 is connected to the plurality of legs 12 by way of the collar 24. The lines 26 are connected to the lower end 31 of the first portion 30 of post 14. The second portion 32 of the post 14 is affixed to the first portion 30. In particular, in the preferred embodiment, the second portion 32 is rotatably mounted within the interior of the first portion 30 (although this could be arranged in a vice-verse relationship). The first portion 30 is axially aligned with the second portion 32 so that the post 14 extends vertically. The second portion 32 will have a flange that extends outwardly of an exterior surface thereof so as to abut the top of the first portion 30 when the second portion 32 is installed into the first portion.

The arm 16 is shown as extending at an upward angle from a handgrip 34 toward an opposite end 36. The arm 16 has a first portion 38 and a second portion 40. The first portion 38 extends radially outwardly relative to the post 32. The second portion 40 also extends radially outwardly relative to the post 32. The first portion 38 is axially aligned with the second portion 40 and can be integrally formed therewith so as to have an extended elongate configuration. The handgrip 34 is located at the end of the first portion. It can be seen that the first portion 38 has a length that is longer than the second portion 40. The handgrip 34 is angled downwardly at an obtuse angle from the first portion 38. It can be seen that the end 36 of the arm 16 is higher than the handgrip 34.

In FIG. 1, there is a tubular member 42 that is affixed to the arm 16 and extends downwardly therefrom. A first strut 44 extends from the tubular member 42 toward a central location on the first portion 38 of the arm 16. A second strut 47 extends from the tubular member 42 toward a central portion of the second portion 40 of the arm 16. The tubular member 42 can be fitted over the outer diameter of the second portion 32 of the post 14 so as to be in rotatable relation thereto. As such, a movement of the handgrip 34 causes the arm 16 to rotate relative to the post 14 so as to cause a corresponding movement of the opposite end 36 of the arm 16.

The lifting assembly 18 includes a reel 46 that is generally affixed adjacent to the handgrip 34. The reel 46 can be part of a winch, a hand crank, or a similar device. A suitable braking mechanism should be provided on the reel 46 so as to fix a rotatable position of the reel. A line 48 extends around the reel 46 and also extends along the arm 16. The line 48 has an opposite end 50 that extends outwardly of the opposite end 36 of the arm 16. A hook or grasping device 52 is located generally at the end of the line 50. As such, when the line 48 is played out by the reel 46, the hook 52 can lower downwardly. When the line 48 is played inwardly, then the hook 52 can lift upwardly. The reel 46 allows the line 48 to extend and retract. A plurality of rollers 54 can be provided on the arm 16 so as to allow the line 48 to extend thereover and to facilitate the movement of the line 48.

It can be seen in FIG. 1 that there is a foot 60 that is located at the lower end 22 of the leg 12. The foot 60 has a diameter greater than a cross-section of the leg 12. The foot 60 can be placed at the lower end of each of the leg so as to enhance the stability of the plurality of legs 12 and of the cooking stand 10. The foot 60 has a hole therein. A stake 62 can be introduced through such a hole so as to secure the foot 60 and the cooking stand 10 to an underlying surface.

FIG. 1 shows the operation of the present invention. In particular, there is a cooking basket 64 having a handle 66 extending therefrom. A boiling pot 68 is illustrated as located below the cooking basket 64. The boiling pot 68 is located upon a heat source 70, such as a fire. In normal use, the hook 52 can engage the handle 66 of the cooking basket 64 so as to raise or lower the cooking basket 64 from or into the interior of the boiling pot 68. In actual use, the arm 16 can be rotated away from the boiling pot 68 so that the cooking basket 64 can be located a safe distance away from the heat source 70. In this position, the crawfish, or other food item, can be introduced into the basket. The arm 16 can then be rotated in an elevated position so that the cooking basket 64 resides directly upon and over the boiling pot 68. The reel 46 can then play out the line 48 so that the hook 52 lowers so as to thereby cause the cooking basket 64 to lower and drop into the boiling pot 68. After cooking, the reverse action can be carried out so as to lift the heated cooking basket 64 and to rotate the cooking basket 64 away from the heat source 70.

In FIG. 1, it can be seen that the heat source 70 and the boiling pot 68 are located between an adjacent pair of the plurality of legs 42. This configuration provides additional stability to the boiling pot 68 and the heat source 70 while, at the same time, enhance and the stability of the cooking stand 10. If necessary, a table 72 can be provided between another adjacent pair of the plurality of legs 12. As such, the cooking basket 64 can be rotated and lowered so as to reside upon the top surface of the table 72. In all circumstances, the person carrying out the cooking activity is forced to stand a significant distance away from the heat source 70 and the boiling pot 68. As such, the present invention effectively avoids burns to the person doing the cooking.

FIG. 2 shows a plan view of the cooking stand 10. As can be seen, the plurality of legs 12 includes a first leg 80, a second leg 82, a third leg 84, and a fourth leg 86. Each of the legs are separated by 90°. The post 14 is located centrally of the plurality of legs 12. The arm 16 is illustrated as extending above the plurality of legs 12.

In FIG. 2, it can be seen that there is a boiling pot 88 that is securely positioned between the first leg 80 and the second leg 82. Another boiling pot 90 can be positioned between the first leg 80 and the fourth leg 86. A fryer pot 92 is illustrated as being positioned between the second leg 84 and the third leg 86. An optional spill tray 94 can be located below the fryer pot 92. The spill tray 94 will have a raised edge of so as to collect any spilled oil from the fryer pot 92. If desired, this spill tray 94 can be filled with cat litter so as to absorb the spilled oil. The arm 16 can be manipulated from any position so as to carry out the necessary cooking activities.

FIG. 3 shows the foot pad 60. The footpad 60 includes a receptacle 96 therein that receives the lower end of the leg 12. A hole 94 can be provided on the footbed 60 so as to allow the stake 62 to be inserted therein so as to secure the cooking stand 10 of the present invention. It can be seen that the foot 60 has a circular configuration. Of course, a wide variety of shapes, sizes and configurations of through foot pad can also be used with cooking stand 10.

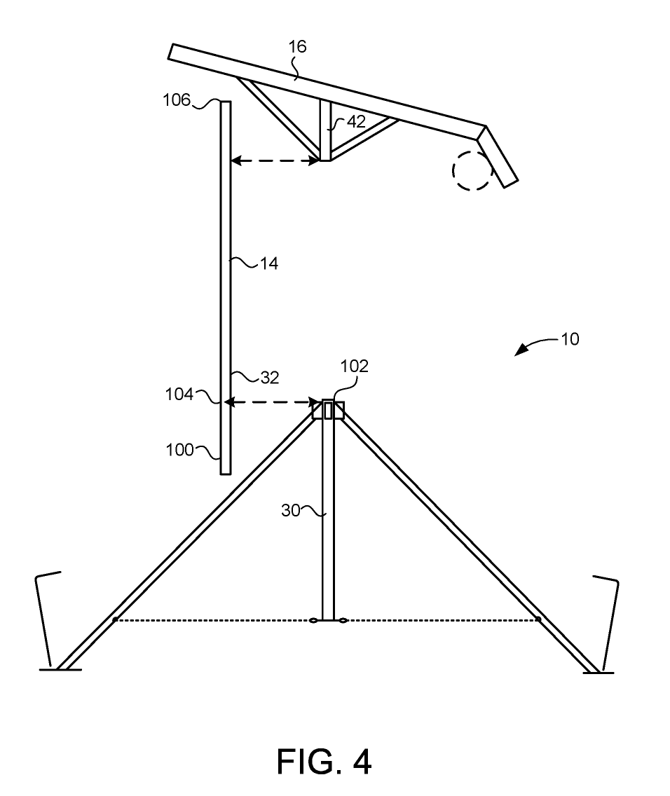

FIG. 4 shows an exploded view of the cooking stand 10 of the present invention. In particular, FIG. 4 shows that the post 14 has a first portion 30 and a second portion 32. The end 100 of the first portion 32 of post 14 will be received in the upper end 102 of the first portion 30. A flange 104 extends outwardly of the outer diameter of the second portion 32 of the post 14 so as to abut the top end 102 of the first portion 30 of the post.

FIG. 4 further shows that the arm 16 has a tubular member 42 that will be received by the upper end 106 of the second portion 32 of the post 14. If desired, another flange can be provided at the outer diameter of the second portion 32 of the post 14 so as to fix a position of the tubular member 42. Alternatively, the upper and 106 of the second portion 32 of post 10 can simply abut the inner end of the tubular member 14.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A cooking stand apparatus comprising:
a plurality of legs;
a post extending upwardly from said plurality of legs;
an arm connected adjacent an upper end of said post opposite said plurality of legs; and
a lifting assembly affixed adjacent an end of said arm away from said post, said lifting assembly adapted to raise or lower an item relative to said plurality of legs.

2. The cooking stand apparatus claim 1, said plurality of legs comprising four legs that extend radially outwardly of said post.

3. The cooking stand apparatus of claim 1, further comprising:
a collar extending around said post, said plurality of legs having an upper end that is pivotally attached to said collar, said collar being movable between an upper position and a lower position, said plurality of legs being retracted in said upper position, said plurality of legs being extended in said lower position.

4. The cooking stand apparatus of claim 3, further comprising:
a line extending between said plurality of legs, said line limiting an angular position of said plurality of legs in the extended position.

5. The cooking stand apparatus of claim 1, said post having a first portion and a second portion, said first portion being connected or interconnected to said plurality of legs, said second portion being rotatable relative to said first portion and axially aligned with said first portion.

6. The cooking stand apparatus of claim 5, said second portion having a lower end received within an upper end of said first portion, said second portion having a flange that extends radially outwardly of an exterior surface of said first portion, said flange abutting said upper end of said first portion.

7. The cooking stand apparatus of claim 1, said arm having an upper end and a lower end, said arm affixed to said post so as to extend at an angle upwardly from said lower end toward said upper end.

8. The cooking stand apparatus of claim 7, further comprising:
a handgrip affixed to said lower end of said arm.

9. The cooking stand apparatus of claim 8, said handgrip comprising an angular section that extends downwardly from said lower end of said arm at an obtuse angle with respect to a longitudinal axis of said arm.

10. The cooking stand apparatus of claim 7, said arm having a first portion that extends radially outwardly of said post and a second portion that extends radially outwardly of said post, said first portion being axially aligned with said second portion.

11. The cooking stand apparatus of claim 10, said first and second portions of said arm being integrally formed together.

12. The cooking stand apparatus of claim 7, said arm being having a tubular member that extends downwardly from the underside thereof, said tubular member being connected to said upper end of said post.

13. The cooking stand apparatus of claim 12, said tubular member receiving said upper end of said post in an interior thereof, said tubular member and said arm being rotatable relative to said post.

14. The cooking stand apparatus of claim 10, further comprising:
a first strut affixed to a first portion of said arm and to said tubular member; and
a second strut affixed to a second portion of said arm and to said tubular member.

15. The cooking stand apparatus of claim 1, said lifting assembly comprising:
a reel;
a line extending around said reel and along said arm, said line having an end opposite said reel that extends downwardly from said arm; and
a hook or grasping device affixed to said end of said line.

16. The cooking stand apparatus of claim 15, said lifting assembly further comprising:
a plurality of rollers rotatably mounted interior of said arm, said line extending over said plurality of rollers within said arm.

17. The cooking stand apparatus of claim 15, further comprising:
a handcrank or a winch cooperative with said reel so as to raise or lower said hook or grasping device at said end of said line.

18. The cooking stand apparatus of claim 1, further comprising:
a plurality of feet respectively affixed to a lower end of said plurality of legs, each of said plurality of feet having a diameter greater than a width of a cross-section of the leg, each of said plurality of feet having a horizontal orientation when said plurality of legs are in an extended position.

19. The cooking stand apparatus of claim 1, the item comprising:
a cooking container releasably connected to said lifting assembly, said lifting assembly adapted to raise or lower said cooking container toward or away from a heat source.
